(19) United States
(12) Patent Application Publication
(10) Pub. No.: US 2009/0109579 A1
(43) Pub. Date: Apr. 30, 2009

(54) MAGNETIC RECORDING MEDIUM, MANUFACTURING METHOD THEREOF AND MAGNETIC STORAGE APPARATUS

(75) Inventors: Hideaki Takahoshi, Higashine (JP); Hisato Shibata, Higashine (JP); Shinya Sato, Higashine (JP); Isatake Kaitsu, Kawasaki (JP); Akira Kikuchi, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/198,648

(22) Filed: Aug. 26, 2008

(30) Foreign Application Priority Data
Oct. 30, 2007 (JP) 2007-282524

(51) Int. Cl. G11B 5/33

(52) U.S. Cl. 360/324.2

(57) ABSTRACT

A magnetic recording medium has a substrate, a first granular layer formed on the substrate, the first granular layer having a plurality of a first magnetic grains and a first oxide for separating the plurality of first magnetic grains from one another. A non-magnetic layer is formed on the first granular layer. The second granular layer is formed on the non-magnetic layer which has a plurality of second magnetic grains and a second oxide for separating the plurality of second magnetic grains from one another. The anisotropic magnetic field of the first granular layer is more intensive than that of the second granular layer.

### CROSS-REFERENCE TO RELATED APPLICATION

This application is based upon and claims the benefit of priority of the prior Japanese Patent Application No. 2007-282524, filed on Oct. 30, 2007, the entire contents of which are incorporated herein by reference.

### BACKGROUND

1. Field

The embodiments discussed herein are directed to a magnetic recording medium used for a hard disk drive etc, a manufacturing method thereof and a magnetic storage apparatus.

2. Description of the Related Art

For a magnetic storage apparatus including a magnetic disk drive, a tunnel magneto-resistance element used as a read head and a perpendicular magnetic recording media contribute to increases in recording density. However, even higher recording density is required.

To achieve the higher recording density, noise reduction of the perpendicular magnetic recording medium is necessary. Japanese Laid-open Patent Publication 2006-48900 discloses studies on fining of magnetic grains and recording layers having a granular structure. In the recording layer having the granular structure, magnetic couplings among magnetic grains are reduced by non-magnetic material. However, fining magnetic grains or using the recording layer having the granular structure decreases stability to thermal disturbance and makes keeping an orientation of magnetization in writing difficult. A material having a stable magnetic energy resistant to thermal disturbance may be used for the granular layer. However, such material interferes with reversal of magnetization in writing by an external magnetic field, that is data overwriting.

Thus, achieving both good overwrite properties and thermal stability is difficult with a conventional magnetic recording medium.

### SUMMARY

In accordance with an aspect of an embodiment, a magnetic recording medium has a substrate. A first granular layer formed on the substrate. The first granular layer has a plurality of first magnetic grains and a first oxide for separating the plurality of first magnetic grains from one another. A non-magnetic layer is formed on the first granular layer. A second granular layer is formed on the non-magnetic layer with a plurality of second magnetic grains and a second oxide for separating the plurality of second magnetic grains from one another. The anisotropic magnetic field of the first granular layer is more intensive than that of the second granular layer.

It is an object of the present invention to provide a magnetic recording medium, a manufacturing method of the magnetic recording medium and a magnetic storage apparatus that achieve both reliable overwriting capability and thermal stability.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The embodiments will be explained with reference to the accompanying drawings.

FIG. 1 is a cross sectional view illustrating a structure of a perpendicular magnetic recording medium in accordance with an embodiment of the present invention.

FIG. 2 illustrates the structure and functionalities of the perpendicular magnetic recording medium in accordance with the embodiment of the present invention.

FIG. 3 illustrates an inner structure of a hard disk drive (HDD).

### DETAILED DESCRIPTION OF THE PREFERRED EMBODIMENTS

The embodiments will be described in detail below with reference to the accompanying drawings.

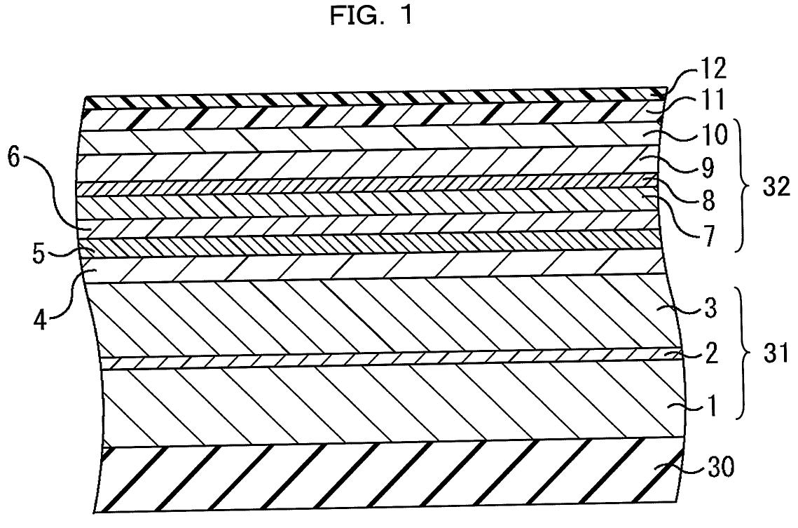

In this embodiment, soft magnetic layer 1, non-magnetic layer 2 and soft magnetic layer 3 are deposited on non-magnetic substrate 30, as shown in FIG. 1. The substrate has a circular shape. The soft magnetic layer 1, non-magnetic layer 2 and soft magnetic layer 3 form a soft magnetic underlayer 31.

Non-magnetic substrate 30 can be made of, for example, plastic, crystallized glass, hardened glass, silicon (Si) or aluminum alloy.

Soft magnetic layers 1 and 3 are made of, for example, amorphous or microcrystalline material containing Iron (Fe), cobalt (Co) and/or nickel (Ni). Wolfram (W), hafnium (Hf), carbon (C), chromium (Cr), boron (B), copper (Cu), titanium (Ti), vanadium (V), niobium (Nb), zirconium (Zr), platinum (Pt), palladium (Pd) and/or tantalum (Ta) may be added to those elements. For example, soft magnetic layers 1 and 3 may be made of amorphous or microcrystalline FeCoNbZr, CoZrNb, CoNbTa, FeCoZrNb, FeCoZrTa, FeCoB, FeCoCrB, NiFeSiB, FeAlSi, FeTaC, FeHfC or NiFe. Optimally, the soft magnetic layers are made of soft magnetic material with 1.0 Tesla or greater of saturation flux density Bs, to obtain sufficient concentration of a magnetic field in writing. Soft magnetic layers 1 and 3 are deposited by plating, direct-current (DC) sputtering, radio frequency (RF) sputtering, pulse DC sputtering, vapor-deposition, chemical vapor deposition (CVD), etc. Thicknesses of soft magnetic layers 1 and 3 range from about 25 to 30 nm. Where the thicknesses are less than 25 nm, a writing property and a reading property may be deteriorated to an insufficient level. Where the thicknesses are greater than 30 nm, manufacturing costs may strikingly increase due to a need for an investment in equipment, etc.

Non-magnetic layer 2 is a non-magnetic metal layer made of, i.e., ruthenium (Ru) or Ru alloy. Non-magnetic layer 2 is deposited by plating, DC sputtering, RF sputtering, pulse DC sputtering, vapor-deposition, CVD, etc. Non-magnetic layer 2 is of sufficient thickness, for example, 0.5 to 1 nm, to provide anti-parallel magnetic coupling between soft magnetic layer 1 and soft magnetic layer 3. The magnetizations of soft magnetic layers 1 and 3 are opposite and therefore antiferromagnetic coupling is caused therebetween. Non-magnetic layer 2 can be made of rhenium (Re), Cr, rhodium (Rh), iridium (Ir), Cu or V as referred to in “S. S. P. Parkin, Phy. Rev. Lett. 67, 3598 (1991)”.

Owing to the structure described above, generation of magnetic domains and magnetic domain walls in soft magnetic underlayer 31 are suppressed.

An Ni alloy intermediate layer 4 is formed on soft magnetic underlayer 31. Ni alloy intermediate layer 4 can be made of, i.e., NiW, NiCr or NiCrW. B or C, or other additive may be added to those alloys. Ni alloy intermediate layer 4 is deposited by plating, DC sputtering, RF sputtering, pulse DC sputtering, vapor-deposition, CVD, etc. A thickness of Ni alloy intermediate layer 4 ranges from, for example, 3 to 10 nm.

Ru intermediate layer 5 is formed on Ni alloy intermediate layer 4. Ru intermediate layer 5 is made of Ru or Ru alloy. Ru intermediate layer 5 is deposited by plating, DC sputtering, RF sputtering, pulse DC sputtering, vapor-deposition, CVD, etc. A thickness of Ru intermediate layer 5 ranges from, for example, 15 to 20 nm.

Non-magnetic containing oxide layer 6 is formed on Ru intermediate layer 5. Non-magnetic containing oxide layer 6 is made of, i.e., CoCr alloy containing oxide. Non-magnetic containing oxide layer 6 is deposited by plating, DC sputtering, RF sputtering, pulse DC sputtering, vapor-deposition, CVD, etc. A thickness of non-magnetic containing oxide layer 6 ranges from, for example, 1 to 5 nm.

A non-magnetic intermediate layer 33 consists of Ni alloy intermediate layer 4, Ru intermediate layer 5 and non-magnetic containing oxide layer 6. Ru intermediate layer 5 and non-magnetic containing oxide layer 6 chiefly magnetically separate soft magnetic underlayer 31 and perpendicular magnetic recording layer 32, as described later. Ni alloy intermediate layer 4 improves crystal orientation of Ru intermediate layer 5.

Granular layer 7, non-magnetic layer 8, granular layer 9 and magnetic layer 10 are continuously deposited on non-magnetic containing oxide layer 6. Perpendicular magnetic recording layer 32 consists of granular layer 7, non-magnetic layer 8, granular layer 9 and magnetic layer 10.

Granular layers 7 and 9 contain a plurality of magnetic grains and oxides among the magnetic grains. The magnetic grains are separated from one another by the oxides. Granular layers 7 and 9 are deposited by plating, DC sputtering, RF sputtering, pulse DC sputtering, vapor-deposition, CVD, etc.

The magnetic grains contained in granular layer 7 are, for example, CoCrPt grains. The ratio of Cr atoms contained in the magnetic grain to total atoms contained in Granular layer 7 is, for example, 5 to 15 at. % and the ratio of Pt atoms contained in the magnetic grain to total atoms contained in Granular layer 7 is, for example, 11 to 25 at. %. The rest of the atom composition is occupied by Co atoms. Granular layer 7 contains, for example, 6 to 13% of the oxide in volume. For example, the oxide is Ti oxide, Si oxide, Cr oxide or Ta oxide. Otherwise, the oxide may be made of a compound of those oxides. A thickness of granular layer 7 ranges from, for example, 7 to 10 nm. Anisotropic magnetic field (Hk) of granular layer 7 ranges from 13,000 to 16,000 oersted (13 kOe to 16 kOe).

The magnetic grains contained in granular layer 9 are, e.g., CoCrPt grains. The ratio of Cr atoms to total atoms contained in granular layer 9 is 7 to 15% and the ratio of Pt atoms to total atoms contained in granular layer 9 is 11 to 17%. The rest of the atom composition is occupied by Co atoms. Granular layer 9 contains, for example, 6 to 13% of the oxide in volume. For example, the oxide is Ti oxide, Si oxide, Cr oxide or Ta oxide. Otherwise, the oxide may be made of a compound of those oxides. A thickness of granular layer 9 ranges from, for example, 5 to 10 nm. Anisotropic magnetic field (Hk) of granular layer 9 ranges from 10,000 to 13,000 Oe (10 kOe to 13 kOe).

The magnetic grains contained in granular layers 7 and 9 are not necessarily the CoCrPt grains. The magnetic grains may contain magnetic grains of CoCrPt alloy or CoCr alloy containing Pt, B, Cu and/or Ta.

Non-magnetic layer 8 is a non-magnetic metal layer made of Ru or Ru alloy. For example, Ru alloy is RuCo, RuCr, RuNi, RuFe, RuRh, RuPd, RuOs, RuIr or RuPt. Non-magnetic layer 8 is deposited by plating, DC sputtering, RF sputtering, pulse DC sputtering, vapor-deposition, CVD, etc. Non-magnetic layer 8 is of sufficient thickness, i.e., about 0.05 to 1.5 nm, optimally, 0.1 to 1 nm, to provide an anti-parallel magnetic coupling between granular layers 7 and 9. The magnetizations of granular layers 7 and 9 are opposite and a ferromagnetic exchange-coupling is caused therebetween. Alternatively, non-magnetic layer 8 may be made of Re, Cr, Rh, Ir, Cu or V.

Magnetic layer 10 can be made of, e.g., CoCrPt alloy such as CoCrPtB, CoCrPtCu, CoCrPtAg, CoCrPtAu, CoCrPtTa, and CoCrPtNb. The ratio of Cr atoms to total atoms contained in magnetic layer 10 is 17 to 22 at. % and the ratio of Pt atoms to total atoms contained in magnetic layer 10 is 11 to 17 at. %. The rest of the atom composition is occupied by Co atoms and additive element. Because of the absence of oxides, a plurality of magnetic grains contact one another in magnetic layer 10. Magnetic layer 10 is deposited by plating, DC sputtering, RF sputtering, pulse DC sputtering, vapor-deposition, CVD, etc. A thickness of magnetic layer 10 ranges from, for example, 5 to 10 nm. Magnetic layer 10 may be made of crystallized material or amorphous material. An anisotropic magnetic field (Hk) of magnetic layer 10 ranges from 6,000 to 10,000 Oe (6 kOe to 10 kOe).

Carbon protective layer 11 is formed on magnetic layer 10. Carbon protective layer 11 is deposited by CVD etc. A thickness of carbon protective layer 11 ranges from, for example, 2.5 to 4.5 nm. Lubrication layer 12 is formed on carbon protective layer 11. Lubrication layer 12 is a layer of coated lubricant. A thickness of lubrication layer 12 is, e.g., 1 nm.

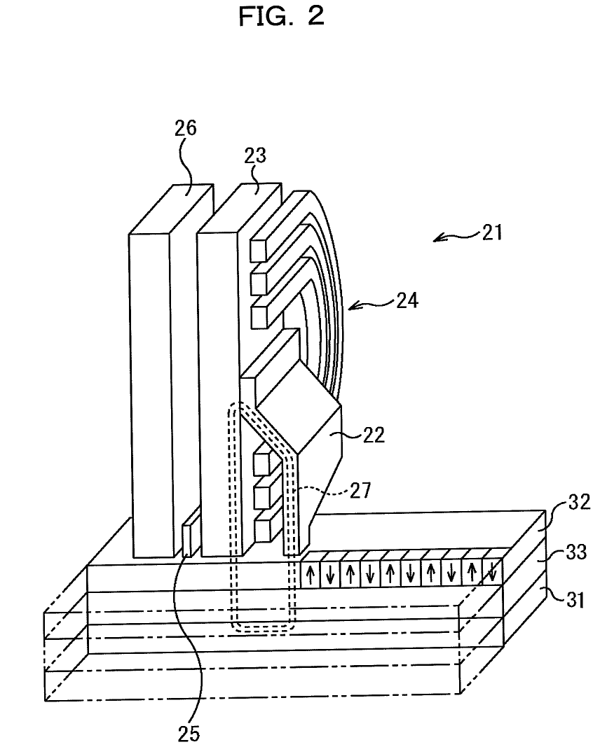

Data is written onto and read from the perpendicular magnetic recording medium having the structure described above by a magnetic head shown in FIG. 2. Magnetic head 21 for perpendicular magnetic recording medium has a main magnetic pole 22 for writing, auxiliary magnetic pole 23 and coil 24. Further, magnetic head 21 has magnetoresistive element 25 for reading, and a shield 26. Auxiliary magnetic pole 23 serves as a shield to magnetoresistive element 25. In writing, current is applied to coil 24, thereby circulating magnetic flux 27 through main magnetic pole 22 and auxiliary magnetic pole 23. Magnetic flux 27 goes through recording layer 6 from main magnetic pole 22. Then the magnetic flux 27 goes through soft magnetic underlayer 31. Thereafter, the magnetic flux 27 goes back to auxiliary magnetic pole 23. Thus, magnetizations of perpendicular magnetic recording layer 32 are oriented either upward or downward for each recording bit according to the direction of the magnetic flux.

In this embodiment, perpendicular magnetic recording layer 32 has granular layers 7 and 9 that are separated magnetically by non-magnetic layer 8. Anisotropic magnetic fields of granular layers 7 and 9 are properly specified. Thus, perpendicular magnetic recording layer 32 ensures intense anisotropic magnetic fields together with an enhanced overwrite property. In other words, the thermal stability and the overwrite property are realized at the same time. Further, since magnetic layer 10 is formed on granular layer 9, HDI (hard disk interface) property, control of magnetic property and electromagnetic conversion property are excellent.

With the structure according to this embodiment, granular layer 7 having a relatively intense anisotropic magnetic field is stable in thermal disturbances. Thus, granular layer 9, which is magnetically coupled with granular layer 7, is also stable in thermal disturbances. Magnetization of granular layer 9, whose anisotropic magnetic field is relatively weak, is reversed by a magnetic field in writing before the magnetization of granular layer 7 is reversed. Thereafter, the magnetization of granular layer 7, whose anisotropic magnetic field is relatively strong, is reversed by the magnetic field in writing and a ferromagnetic coupling force from the magnetization of granular layer 9. Therefore, the thermal stability is obtained together with the overwrite property.

By forming magnetic layer 10 according to this embodiment, the effects described above are enhanced. In addition, size of the grains in the granular layers and distribution of the anisotropic magnetic fields are equalized; highly dense layers improve corrosion-resistance; and HDI properties including a head flying are improved due to smoothness of the surface.

When the anisotropic magnetic field of granular layer 7 is less than 13,000 Oe (13 kOe), sufficient magnetic energy and thermal stability are not obtained. When the anisotropic magnetic field of granular layer 7 is greater than 16,000 Oe (16 kOe), the overwrite property is deteriorated. Hence, the anisotropic magnetic field of granular layer 7 is specified in the range of 13 to 16 kOe. The anisotropic magnetic field within the range is achieved with the structure described above.

When the anisotropic magnetic field of granular layer 9 is less than 10,000 Oe (10 kOe), sufficient magnetic energy and thermal stability are not obtained. When the anisotropic magnetic field of granular layer 9 is greater than 13,000 Oe (13 kOe), the overwrite property is deteriorated. Hence, an anisotropic magnetic field of granular layer 9 is specified in the range of 10 to 13 kOe. The anisotropic magnetic field in the range is achieved with the structure described above.

To manufacture the perpendicular magnetic recording medium described above, the aforementioned layers are formed on non-magnetic substrate 30. After forming lubrication layer 12, roughness and foreign particles on the surface may be eliminated with an abrasive tape etc.

With this manufacturing method, a perpendicular magnetic recording medium having both thermal stability and a good overwrite property may be realized.

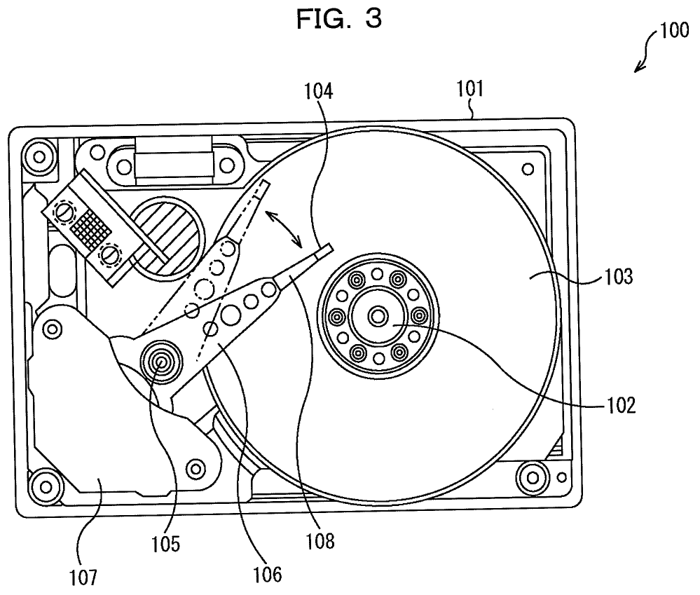

Now, an example of the magnetic storage apparatus having the perpendicular magnetic recording medium according to the embodiment described above—a hard disk drive (HDD)—is disclosed. FIG. 3 shows the inner structure of the HDD.

Housing 101 of HDD 100 houses a rotary shaft 102, a magnetic disk 103 mounted on rotary shaft 102, a head slider 104 having a magnetic head to write data onto and read data from magnetic disk 103, a suspension 108 to support the head slider 104, an arm shaft 105, and a carriage arm 106 to which suspension 108 is attached moves about arm shaft 105 and an arm actuator 107 drives the carriage arm 106 over the surface of the magnetic disk 103. The magnetic disk 103 is the perpendicular magnetic recording medium according to the embodiment described above.

Now an actual experiment conducted by the inventors of the present invention will be described. In the experiment, three samples were made according to the embodiment described above (the embodiment samples). Two more samples were made according to the embodiment excluding non-magnetic layer 8 (the comparative samples). Thicknesses of each layer are shown in Table 1. Anisotropic magnetic fields of each layer included in perpendicular magnetic recording layer 32 are shown in Table 2.

TABLE 1

| | thickness |
|---|---|
| structure of medium | (nm) |
| soft magnetic layer 1 | 25 |
| non-magnetic layer 2 | 0.5 |
| soft magnetic layer 3 | 25 |
| Ni alloy intermediate layer 4 | 8 |
| Ru intermediate layer 5 | 20 |
| non-magnetic containing oxide layer 6 | 3.5 |
| granular layer 7 | 7.5 |
| non-magnetic layer 8 | 0.25 |
| granular layer 9 | 5 |
| magnetic layer 10 | 7 |
| carbon protective layer 11 | 3.5 |

TABLE 2

| | the embodiment | the comparison |
|---|---|---|
| | samples | samples |
| granular layer 7 | 15 kOe | 14 kOe |
| non-magnetic | (non-magnetic) | — |
| layer 8 | | |
| granular layer 9 | 13 kOe | 13 kOe |
| magnetic layer 10 | 8 kOe | 8 kOe |

Coercivity, write core width, resolution, overwrite property, nonlinear transition shift (NLTS), cross talk indexes, side-erasing indexes and Viterbi Trellis Margin (VTM) of those samples are shown in Table 3.

TABLE 3

| | | write | | | | | | |
|---|---|---|---|---|---|---|---|---|
| | | core | | overwrite | | cross | side- | |
| | coercivity | width | resolution | property | NLTS | talk | erasing | |
| | (Oe) | (μm) | (%) | (dB) | (%) | (dB) | (dB) | VTM |
| the | 4450 | 0.144 | 65.9 | −48.0 | 21.5 | −17.8 | −0.7 | 2.22 |
| embodiment | 4606 | 0.142 | 66.7 | −47.3 | 20.9 | −19.4 | −0.6 | 2.28 |
| samples | 4822 | 0.138 | 67.0 | −47.5 | 21.0 | −21.1 | −0.6 | 2.40 |
| the | 4675 | 0.151 | 65.0 | −49.3 | 23.7 | −16.5 | −0.9 | 2.35 |
| comparison | 4345 | 0.159 | 64.1 | −49.2 | 23.4 | −13.4 | −1.1 | 2.36 |
| samples | | | | | | | | |

The coercivities of the embodiment samples and the experimental samples were equal.

The write core width indicates a width in which data can be correctly written. As the width is reduced, the track recording density is increased. The write core widths of the embodiment samples were narrower than those of the comparative samples.

The resolutions of the embodiment samples were higher than those of the comparative samples.

The overwrite property was evaluated by a ratio between a signal read out where data was written at 124 kb per inch (kBPI) and a signal read out where data was written at 495 kBPI. The value of the overwrite property was optimal in the proximity to −40 dB. The overwrite properties of the embodiment samples were superior to those of the comparative samples.

Lower NLTS is desirable. The NLTSs of the embodiment samples were lower than those of the comparative samples.

As the cross talk index becomes lower, cross talk is suppressed. The cross talk indexes of the embodiment samples were lower than those of the comparative samples.

As the side-erasing index nears zero, side-erasing is suppressed. The side-erasing indexes of the embodiment samples were lower than those of the comparative samples.

The VTM is an error rate of signals corrected by Viterbi decoding and proportional to the error rate. The VTMs of the embodiment samples were lower than those of the comparative samples.

Japanese Laid-open Patent Publication 2006-48900 discloses a perpendicular magnetic recording medium having a non-magnetic coupled layer formed between magnetic recording layers having a granular structure. However, there is no reference in the publication with respect to preferable anisotropic magnetic fields of each magnetic recording layer. As concrete numeric values, 18.7 kOe and 13.2 kOe are cited in paragraph 0029. However, the values appear to be too high to achieve sufficient overwrite property. Values of 20.0 kOe and 11.1 kOe are cited in paragraph 0037. However, 20.0 kOe appears to be too high. Japanese Laid-open Patent Publication 2006-48900 does not disclose that a magnetic layer is continuously formed on a granular layer.

It is not desired to limit the inventive embodiments to perpendicular magnetic recording media. The present invention may apply to longitudinal magnetic recording media, as well.

In the present invention, a non-magnetic layer is formed between the first and second granular layers whose anisotropic magnetic fields are properly specified. Owing to the interaction exerted between the layers, both the overwrite property and thermal stability are realized.

The turn of the embodiments isn't a showing the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic recording medium, comprising:
a substrate;
a first granular layer formed on said substrate, having a plurality of a first magnetic grains and a first oxide for separating said plurality of first magnetic grains from one another;
a non-magnetic layer formed on said first granular layer; and
a second granular layer formed on said non-magnetic layer, having a plurality of second magnetic grains and a second oxide for separating said plurality of second magnetic grains from one another,
wherein an anisotropic magnetic field of said first granular layer is more intensive than that of said second granular layer.

2. The magnetic recording medium according to claim 1, further comprising:
a magnetic layer formed continuously on said second granular layer, wherein
an anisotropic magnetic field of said second granular layer is more intensive than that of said magnetic layer.

3. The magnetic recording medium according to claim 1, wherein
the anisotropic magnetic field of said first granular layer ranges from 13,000 to 16,000 oersted (Oe), and
the anisotropic magnetic field of said second granular layer ranges from 10,000 to 13,000 Oe.

4. The magnetic recording medium according to claim 1, wherein said first magnetic grain is a CoCrPt grain,
a ratio of a Cr atom contained in said first magnetic grain to total atoms contained in said first granular layer ranges from 5 to 15 at. %,
a ratio of a Pt atom contained in said first magnetic grain to total atoms contained in said first granular layer ranges from 11 to 25 at. %, and
a ratio in volume of said first oxide included in said first granular layer ranges from 6 to 13%.

5. The magnetic recording medium according to claim 1, wherein
said second magnetic grain is a CoCrPt grain,
a ratio of a Cr atom contained in said second magnetic grain to total atoms contained in said second granular layer ranges from 7 to 15 at. %,
a ratio of a Pt atom contained in said second magnetic grain to total atoms contained in said second granular layer ranges from 11 to 17 at. %, and
a ratio in volume of said second oxide included in said second granular layer ranges from 6 to 13%.

6. The magnetic recording medium according to claim 1, wherein
said first and second oxides are one element selected from among titanium (Ti) oxide, silicon (Si) oxide, chromium (Cr) oxide and tantalum (Ta) oxide.

7. The magnetic recording medium according to claim 1, wherein
said non-magnetic layer is made of ruthenium (Ru) or Ru alloy.

8. The magnetic recording medium according to claim 7, wherein
said Ru alloy is selected from among RuCo, RuCr, RuNi, RuFe, RuRh, RuPd, RuOs, RuIr and RuPt.

9. The magnetic recording medium according to claim 1, wherein
a thickness of said non-magnetic layer ranges from 0.05 to 1.5 nm.

10. The magnetic recording medium according to claim 1, wherein
said non-magnetic layer causes a ferromagnetic exchange-coupling between said first granular layer and said second granular layer, and
magnetization of said first and second granular layers are reversed simultaneously by applying an external magnetic field.

11. The magnetic recording medium according to claim 1, further comprising:
a soft magnetic underlayer formed between said substrate and said first granular layer; and
a non-magnetic intermediate layer for separating said soft magnetic underlayer and a recording layer including said first granular layer, said non-magnetic layer and said second granular layer.

12. The magnetic recording medium according to claim 11, wherein
said non-magnetic intermediate layer includes at least a layer made of Ru or Ru alloy.

13. The magnetic recording medium according to claim 12, wherein
said soft magnetic underlayer includes a first soft magnetic layer, a second non-magnetic layer formed on said first soft magnetic layer and a second soft magnetic layer formed on said second non-magnetic layer.

14. A method of manufacturing a magnetic recording medium, comprising the steps of:
forming a first granular layer on a substrate, having a plurality of first magnetic grains and a first oxide separating said plurality of first magnetic grains from one another and whose anisotropic magnetic field ranges from 13,000 to 16,000 Oe;
forming a non-magnetic layer on said first granular layer;
forming a second granular layer on said non-magnetic layer, having a plurality of second magnetic grains and a second oxide separating said plurality of second magnetic grains from one another and whose anisotropic magnetic field ranges from 10,000 to 13,000 Oe; and
forming continuously a magnetic layer on said second granular layer.

15. The manufacturing method of the magnetic recording medium according to claim 14, wherein
said first magnetic grain is a CoCrPt grain,
a ratio of a Cr atom contained in said first magnetic grain to total atoms contained in said first granular layer ranges from 5 to 15 at. %,
a ratio of a Pt atom contained in said first magnetic grain to total atoms contained in said first granular layer ranges from 11 to 25 at. %, and
a ratio in volume of said first oxide included in said first granular layer ranges from 6 to 13%.

16. The manufacturing method of claim 14, wherein
said second magnetic grain is a CoCrPt grain,
a ratio of a Cr atom contained in said second magnetic grain to total atoms contained in said second granular layer ranges from 7 to 15 at. %,
a ratio of a Pt atom contained in said second magnetic grain to total atoms contained in said second granular layer ranges from 11 to 17%, and
a ratio in volume of said second oxide included in said second granular layer ranges from 6 to 13%.

17. The manufacturing method of claim 14, wherein
said first and second oxides are one oxide selected from among Ti oxide, Si oxide, Cr oxide and Ta oxide.

18. The manufacturing method of claim 14, wherein
a thickness of said non-magnetic layer ranges from 0.05 to 1.5 nm.

19. The manufacturing method of claim 14, further comprising the steps of:
forming a soft magnetic underlayer on said substrate; and
forming a non-magnetic intermediate layer on said soft magnetic underlayer to magnetically separate said soft magnetic underlayer from a recording layer including said first granular layer, said non-magnetic layer, said second granular layer and said magnetic layer before forming said first granular layer.

20. A magnetic storage apparatus, comprising:
a magnetic recording medium including a substrate, a first granular layer formed on said substrate, having a plurality of a first magnetic grains and a first oxide for separating said plurality of first magnetic grains from one another, a non-magnetic layer formed on said first granular layer, and a second granular layer formed on said non-magnetic layer, having a plurality of second magnetic grains and a second oxide for separating said plurality of second magnetic grains from one another; and
a magnetic head for writing data onto and reading data from said magnetic recording medium,
wherein an anisotropic magnetic field of said first granular layer is more intensive than that of said second granular layer.
